(19) United States
(12) Patent Application Publication
(10) Pub. No.: US 2018/0314312 A1
(43) Pub. Date: Nov. 1, 2018

(54) PC AS A POWER OVER WIFI STATION FOR SMALL DEVICES

(71) Applicant: LENOVO (SINGAPORE) PTE. LTD., Singapore (SG)

(72) Inventors: Koji Kawakita, Tokyo (JP); Kazuo Fujii, Tokyo (JP); Yasumichi Tsukamoto, Tokyo (JP); Naoyuki Araki, Tokyo (JP)

(73) Assignee: LENOVO (SINGAPORE) PTE. LTD., Singapore (SG)

(21) Appl. No.: 15/499,809

(22) Filed: Apr. 27, 2017

(51) Int. Cl. G06F 1/32; H04L 12/24; H04W 52/32

(52) U.S. Cl. CPC G06F 1/3209; H04L 41/0803; H04W 84/12; G06F 1/3287; H04W 52/32

(57) ABSTRACT

A personal computer providing power over Wi-Fi is provided, the personal computer comprising: a plurality of Wi-Fi antennas; and a processor configured to: determine a data activity level for the plurality of Wi-Fi antennas; in response to the determining of the data activity level, assign each of the plurality of Wi-Fi antennas to one of data transmission and power transmission, wherein the assigning is based on the data activity level; and send power packets using each of the plurality of Wi-Fi antennas that is assigned to power transmission.

### BACKGROUND OF THE INVENTION

The present invention relates generally to methods and apparatus for wireless power delivery. More particularly, the invention relates to systems for wireless power delivery using a personal computer (PC) with Power Over Wi-Fi.

An increasing number of portable electronic devices and wearable devices are becoming essential to daily life, enabling users to work more efficiently, stay in contact with their social networks, keep tabs on their health, and more. An unfortunate side effect of the proliferation of these electronic devices is the attendant requirement to keep each of these devices charged to be usable. It is easy to accidentally forget a required charger when traveling, or to neglect to connect each and every device for overnight charging, even when chargers are available.

Wireless charging is helping to address some of these concerns by allowing a user to easily charge a device by simply placing the device in close proximity to a wireless charging base station. In this manner, charging of devices becomes much more convenient as the user does not need to carefully mate a charging cable to the device or find a free power outlet to connect a charger.

However, wireless charging still suffers from several drawbacks. First, since the wireless charging base station is often connected to a standard power outlet as with conventional wired chargers, it is also easy to forget to bring the wireless charging base station for travel. Second, it is difficult to gauge the effective range for wireless charging, which is necessary when a user wishes to limit unauthorized use or provide power for others to share. Third, wireless charging capabilities may be provided by a device that is not portable, such as a home or office Wi-Fi router, which restricts the mobility of the user. For example, in the whitepaper by Talla Vamsi, et al. “Powering the next billion devices with wi-fi”, Wi-Fi equipment, or specifically a Wi-Fi router, is used to demonstrate the feasibility of wireless power delivery over Wi-Fi (Talla, Vamsi, et al. “Powering the next billion devices with wi-fi.” Proceedings of the 11th ACM Conference on Emerging Networking Experiments and Technologies. ACM, 2015). However, since the whitepaper focuses on using a Wi-Fi router as the base station for power delivery, the method described is generally limited to home or office use. Since the Wi-Fi router is generally connected to an uplink modem by Ethernet cable, and may also be connected to other wired devices via an integrated switch, it is generally not feasible for the user to travel with the Wi-Fi router. Further, even if the Wi-Fi router is removable, other persons in the household or office may need the Wi-Fi router to access the Internet. Thus, the method described in the whitepaper has limited application for mobile contexts.

As can be seen, there is a need for a convenient and portable method of wirelessly charging devices.

### SUMMARY OF THE INVENTION

In one aspect of the present invention, a personal computer providing power over Wi-Fi is provided, the personal computer comprising: a plurality of Wi-Fi antennas; and a processor configured to: determine a data activity level for the plurality of Wi-Fi antennas; in response to the determining of the data activity level, assign each of the plurality of Wi-Fi antennas to one of data transmission and power transmission, wherein the assigning is based on the data activity level; and send power packets using each of the plurality of Wi-Fi antennas that is assigned to power transmission.

In another aspect of the present invention, a method for providing power over Wi-Fi using a personal computer is provided, the method comprising: determining a data activity level for a plurality of Wi-Fi antennas connected to the personal computer; in response to the determining of the data activity level, assigning each of the plurality of Wi-Fi antennas to one of data transmission and power transmission, wherein the assigning is based on the data activity level; and sending power packets using each of the plurality of Wi-Fi antennas that is assigned to power transmission.

In still another aspect of the present invention, a non-transitory computer readable media containing computer readable instructions is provided. When executed by one or more processors, the computer readable instructions cause: determining a data activity level for a plurality of Wi-Fi antennas connected to a personal computer; in response to the determining of the data activity level, assigning each of the plurality of Wi-Fi antennas to one of data transmission and power transmission, wherein the assigning is based on the data activity level; and sending power packets using each of the plurality of Wi-Fi antennas that is assigned to power transmission.

These and other features, aspects and advantages of the present invention will become better understood with reference to the following drawings, description and claims.

### BRIEF DESCRIPTION OF THE DRAWINGS

FIG. 1 is a schematic block diagram of a system for a personal computer providing power over Wi-Fi, in accordance with an exemplary embodiment of the invention;

FIG. 2A a schematic block diagram of a system for an augmented reality application to adjust a transmission power level of a personal computer providing power over Wi-Fi, in accordance with an exemplary embodiment of the invention;

FIG. 2B and FIG. 2C are example user interfaces of the augmented reality adjustment application of FIG. 2A; and

FIG. 3 is a flow chart of a method for providing power over Wi-Fi using a personal computer in accordance with an exemplary embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The present invention generally may provide methods and apparatus for wireless power delivery. More particularly, the present invention provides systems for wireless power delivery using a personal computer (PC) with Power Over Wi-Fi.

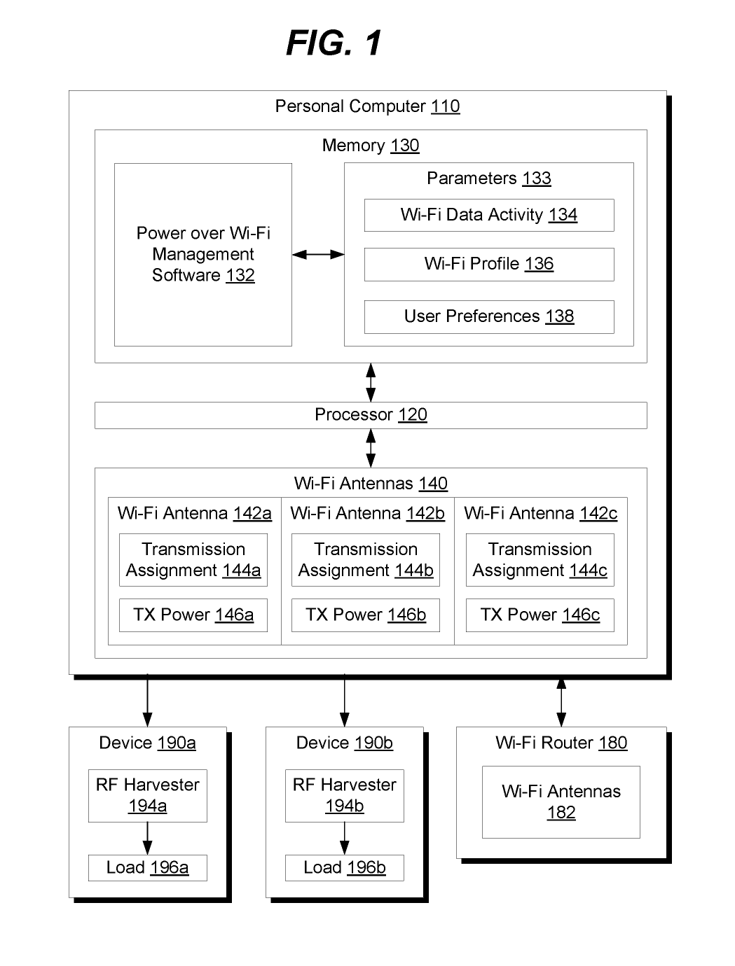

Referring now to FIG. 1, a schematic block diagram of a system for personal computer 110 providing power over Wi-Fi is shown. Personal computer 110 may comprise a portable computer such as a laptop, tablet, hybrid convertible, or other form factor. Personal computer 110 may provide wireless power over Wi-Fi for any number of devices, such as device 190a and device 190b. Additionally, personal computer 110 may concurrently communicate with Wi-Fi router 180 for data communications as usual.

Personal computer 110 may include processor 120, memory 130, and Wi-Fi antennas 140. Memory 130 may include Power over Wi-Fi management software 132, and parameters 133. Parameters 133 may include Wi-Fi data activity 134, Wi-Fi profile 136, and user preferences 138. Wi-Fi antennas 140 may include Wi-Fi antenna 142a, Wi-Fi antenna 142b, and Wi-Fi antenna 142c. Wi-Fi Antenna 142a may include transmission assignment 144a and TX power 146a. Wi-Fi Antenna 142b may include transmission assignment 144b and TX power 146b. Wi-Fi Antenna 142c may include transmission assignment 144c and TX power 146c. Wi-Fi router 180 may include Wi-Fi antennas 182. Device 190a may include RF harvester 194a and load 196a. Device 190b may include RF harvester 194b and load 196b.

An observation is that modern personal computers are often equipped with multiple Wi-Fi antennas to provide sufficient performance to keep up with users' demand for speed and reliability. For example, many personal computers are configured with 2×2 or 3×3 MIMO antennas for high speed wireless access. The configuration shown in FIG. 1 may correspond to 3×3 MIMO antennas, or Wi-Fi antennas 142a, 142b, and 142c.

In many situations, it is not necessary to utilize each and every antenna to provide sufficient network performance for the user. Thus, the present invention assigns one or more antennas exclusively for power transmission based on network conditions. This assignment is represented by transmission assignment 144a, 144b, and 144c. The antennas that are not assigned to power transmission are therefore assigned to data transmission, or normal operation, for example by communicating with Wi-Fi router 180 via Wi-Fi antennas 182. Each transmission assignment 144a-144c may also specify a particular Wi-Fi channel and band, which may be based on a wireless congestion survey to find the least congested Wi-Fi channels. These assignments may be made to non-overlapping band ranges when possible to provide maximum performance for both power delivery and wireless data. While transmission assignment 144a-144c is shown as being a respective part of Wi-Fi antennas 142a-142c, it should be understood that transmission assignment 144a-144c may actually be maintained in memory 130 by Power over Wi-Fi management software 132.

Power over Wi-Fi management software 132 may run as an operating system service or daemon, as a background application, as embedded firmware in a Wi-Fi card, or by any other suitable method. By monitoring one or more parameters 133 such as Wi-Fi data activity 134, Wi-Fi profile 136, and user preferences 138, Power over Wi-Fi management software 132 may dynamically adjust antenna assignments 144a-144c and TX power 146a-146c. This dynamic adjustment may be carried out on a periodic basis and/or based on a threshold change to any of the monitored parameters 133.

RF harvester 194a of device 190a may receive power packets, or Wi-Fi data packets that are optimized for power delivery, from each of Wi-Fi antennas 142a-142c that are assigned to power transmission. RF harvester 194a may harvest the radio frequency energy from the transmitted power packets into a DC voltage, which may be fed into a DC-DC voltage converter such as a boost converter to provide a sufficient minimum voltage for load 196a. Depending on the design of device 190a, a battery may also be included that is recharged using RF harvester 194a. In this manner, device 190a may operate using wireless power provided over Wi-Fi by personal computer 110. Device 190b may operate in a similar manner as device 190a.

Due to FCC regulations of 1 watt maximum Wi-Fi transmit (TX) power, the method described in FIG. 1 may be mostly applicable to small devices with low power requirements, which may include smart watches and other wearables, stylus pens for digitizers, and monitoring devices such as cameras and sensors. However, if regulations are adjusted and/or new Wi-Fi spectrums are made available, then the system described in FIG. 1 could also be applicable to provide wireless power for higher power devices as well.

As discussed above, one problem of existing wireless power delivery systems is the inability for the user to easily visualize the effective range for power delivery. If the device to be charged lacks a charging indicator, it may be difficult for the user to ascertain whether a device is being charged or not. Further, if the user wishes to limit charging to only personal devices, or conversely wishes to share power with friends or colleagues, again it is difficult to discern the effective range for charging.

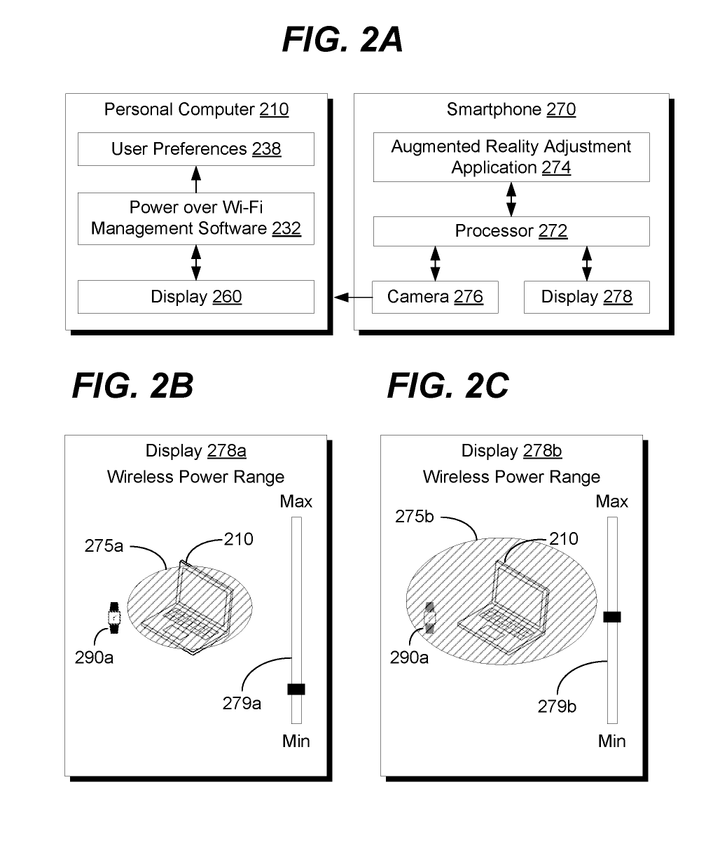

Accordingly, referring now to FIG. 2A, FIG. 2A is a schematic block diagram of a system for an augmented reality application to adjust a transmission power level of a personal computer providing power over Wi-Fi. FIG. 2A includes personal computer 210 and smartphone 270. Personal computer 210 may include user preferences 238, Power over Wi-Fi management software 232, and display 260. Smartphone 270 may include processor 272, augmented reality adjustment application 274, camera 276, and display 278. With respect to FIG. 2A, like numbered elements may correspond to the same elements from FIG. 1.

Power over Wi-Fi management software 232 may prompt the user on display 260 to install an application on his or her smartphone 270, for example by presenting a QR code or a URL. After scanning the QR code and downloading and executing augmented reality adjustment application 274, processor 272 of smartphone 270 may utilize camera 276 to provide an augmented reality, which is shown on display 278. The user may adjust to a desired power level, which is saved in user preferences 238. From that point, personal computer 210 may broadcast power packets using an appropriate TX power from user preferences 238 to cover a desired effective range.

For example, referring now to FIG. 2B, FIG. 2B is an example user interface of augmented reality adjustment application 274 of FIG. 2A. Display 278a depicts a personal computer 210, an effective range 275a, a power slider 279a, and a device 290a. With respect to FIG. 2B, like numbered elements may correspond to the same elements from FIG. 2A and FIG. 1.

Augmented reality adjustment application 274 may first prompt the user to point camera 276 at personal computer 210. Thus, display 278a may provide a realtime display of camera 276. Augmented reality adjustment application 274 may use image processing techniques, as known in the art, to recognize personal computer 210 in images captured by camera 276. Based on the size of personal computer 210 and the known transmission properties of the power packets at a given TX power level set by power slider 279a, the effective range 275a may be calculated and displayed as a virtual overlay emanating from personal computer 210 in display 278a. Thus, the user can readily visualize effective range 275a and see that device 290a is outside of effective range 275a. For example, device 290a may correspond to a smartwatch that the user wants to recharge using Power over Wi-Fi.

Continuing now to FIG. 2C, FIG. 2C is another example user interface of augmented reality adjustment application 274 of FIG. 2A. Display 278b depicts a personal computer 210, an effective range 275b, a power slider 279b, and a device 290a. With respect to FIG. 2C, like numbered elements may correspond to the same elements from FIG. 2A, FIG. 2B, and FIG. 1.

Having understood that device 290a is outside effective range 275a, the user may adjust power slider 279a to increase the TX power, resulting in power slider 279b shown in FIG. 2C. Thus, the effective range expands to effective range 275b, which now encompasses device 290a. The adjusted TX power can be written into user preferences 238 so that the power packets are broadcast using TX power 146a-146c adjusted for the desired coverage area. Accordingly, by utilizing augmented reality adjustment application 274, the user can easily visualize and adjust the effective range of Power over Wi-Fi provided by a personal computer.

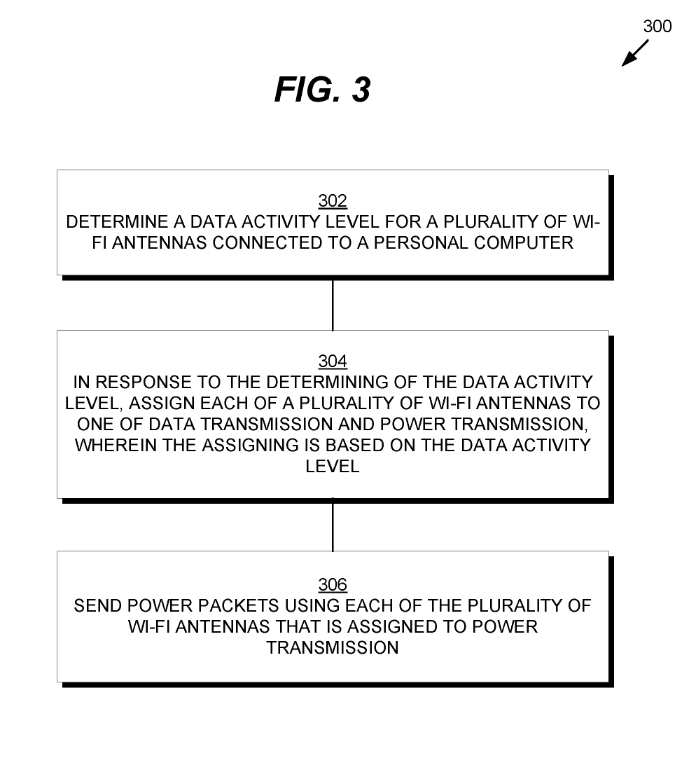

Referring now to FIG. 3, a flow chart illustrates a method 300 for providing power over Wi-Fi using a personal computer. In block 302, power over Wi-Fi management software 132 determines Wi-Fi data activity 134 over Wi-Fi antennas 140 connected to personal computer 110. For example, an operating system of personal computer 110 may provide TX/RX packet statistics for a wireless network adapter using Wi-Fi antennas 140, which are reflected within Wi-Fi data activity 134. Based on Wi-Fi data activity 134, power over Wi-Fi management software 132 can determine the present demand for Wi-Fi data. As discussed previously, block 302 may be initiated on a periodic basis, or after a threshold change is detected in any of parameters 133.

In response to the determination of block 302, block 304 assigns each of Wi-Fi antennas 140, or Wi-Fi antennas 142a-142c, to one of data transmission and power transmission, wherein the assigning is based on Wi-Fi data activity 134 determined in block 302. For example, if Wi-Fi data activity 134 indicates heavy Wi-Fi data use, then transmission assignment 144a and 144b may be set to data transmission, and transmission assignment 144c may be set to power transmission. Conversely, if Wi-Fi data activity 134 indicates light Wi-Fi data use, then transmission assignment 144a may be set to data transmission and transmission assignment 144b and 144c may be set to power transmission.

Besides Wi-Fi data activity 134, the transmission assignments 144a-144c may be based on other criteria from parameters 133. For example, user preferences 138 may indicate a preference for high speed Wi-Fi, or a preference for high speed wireless charging. In this case, user preferences 138 may override or adjust the dynamic adjustment based on Wi-Fi data activity 134. Further, location or use-case specific settings may be utilized. For example, if the user connects to a work network, as identified by Wi-Fi profile 136, then a preference may be given for data rather than power, to provide maximum wireless speed. If the user connects to a home network, as identified by Wi-Fi profile 136, then a preference may be given for power rather than data, to provide maximum charging speed. Besides Wi-Fi profile 136, other location data such as GPS or Bluetooth data may be utilized.

In block 306, each of the Wi-Fi antennas 142a-142c that is assigned to power transmission sends power packets. As discussed above, power packets are data packets that are optimized for power delivery. The actual content of the data packet is not used as data, but only for power delivery. Advantageously, since Wi-Fi antennas 142a-142c that are assigned to power transmission can be dedicated to power transmission, there is no need to restrict transmission to a short interval to avoid impacting data transmission, nor is there a need to synchronize power packets with other Power over Wi-Fi routers, as with a conventional Wi-Fi router antenna that broadcasts both data and power packets. Thus, high performance for both data transmission and wireless charging can be maintained. Further, since the user can adjust the TX power using an augmented reality application as described above, the effective range of the Power over Wi-Fi can be easily visualized and adjusted by the user.

Conveniently, the user may also charge devices even when personal computer 110 is in a low power sleep state. For example, when the user places personal computer 110 into a low power sleep mode, then a special low power use case may be engaged, wherein one or more of Wi-Fi antennas 142a-142c may continue to broadcast wireless power packets during the low power sleep mode, but perhaps using a reduced TX power to conserve the battery life of personal computer 110. Thus, for example, the user can close the lid of personal computer 110 to place personal computer 110 into a sleep mode while placing his smartwatch on top of computer 110 to recharge his smartwatch during the sleep mode.

It should be understood that method 300 as carried out by Power over Wi-Fi management software 132 may be implemented as computer readable instructions that are provided on non-transitory computer readable media, such as a hard disk drive, flash memory, an optical disc, or other media. When executed by processor 120 (or multiple processors), the instructions may cause method 300 to be carried out.

It should be understood, of course, that the foregoing relates to exemplary embodiments of the invention and that modifications may be made without departing from the spirit and scope of the invention as set forth in the following claims.

We claim:

1. A personal computer providing power over Wi-Fi, the personal computer comprising:
a plurality of Wi-Fi antennas; and
a processor configured to:
determine a data activity level for the plurality of Wi-Fi antennas;
in response to the determining of the data activity level, assign each of the plurality of Wi-Fi antennas to one of data transmission and power transmission, wherein the assigning is based on the data activity level; and
send power packets using each of the plurality of Wi-Fi antennas that is assigned to power transmission.

2. The personal computer of claim 1, wherein the determining of the data activity level occurs at periodic intervals.

3. The personal computer of claim 1, wherein the sending of the power packets further occurs during a low power sleep state of the personal computer.

4. The personal computer of claim 1, wherein the assigning of the plurality of Wi-Fi antennas further configures a Wi-Fi channel for each of the plurality of Wi-Fi antennas based on a Wi-Fi congestion survey.

5. The personal computer of claim 1, wherein the assigning is further based on one of a Wi-Fi profile, a location of the personal computer, and a user preference.

6. The personal computer of claim 1, wherein the assigning further configures a transmission power level for each of the plurality of Wi-Fi antennas that is assigned to power transmission.

7. The personal computer of claim 6, wherein the transmission power level is set in response to a user input from an augmented reality application that displays an effective range of the power packets from the personal computer according to the transmission power level.

8. A method for providing power over Wi-Fi using a personal computer, the method comprising:
determining a data activity level for a plurality of Wi-Fi antennas connected to the personal computer;
in response to detecting a threshold change to a monitored parameter, assigning each of the plurality of Wi-Fi antennas to one of data transmission and power transmission, wherein the assigning is based on the data activity level; and
sending power packets using each of the plurality of Wi-Fi antennas that is assigned to power transmission.

9. The method of claim 8, wherein the monitored parameter is one of the data activity level, a Wi-Fi profile, a location of the personal computer, and a user preference.

10. The method of claim 8, wherein the sending of the power packets further occurs during a low power sleep state of the personal computer.

11. The method of claim 8, wherein the assigning of the plurality of Wi-Fi antennas further configures a Wi-Fi channel for each of the plurality of Wi-Fi antennas based on a Wi-Fi congestion survey.

12. The method of claim 8, wherein the assigning is further based on one of a Wi-Fi profile, a location of the personal computer, and a user preference.

13. The method of claim 8, wherein the assigning further configures a transmission power level for each of the plurality of Wi-Fi antennas that is assigned to power transmission.

14. The method of claim 13, wherein the transmission power level is set in response to a user input from an augmented reality application that displays an effective range of the power packets from the personal computer according to the transmission power level.

15. A non-transitory computer readable media containing computer readable instructions that, when executed by one or more processors, causes:
determining a data activity level for a plurality of Wi-Fi antennas connected to a personal computer;
in response to the determining of the data activity level, assigning each of the plurality of Wi-Fi antennas to one of data transmission and power transmission, wherein the assigning is based on the data activity level and further assigns a transmission power level for each of the plurality of Wi-Fi antennas that is assigned to power transmission; and
sending power packets using each of the plurality of Wi-Fi antennas that is assigned to power transmission.

16. The non-transitory computer readable media of claim 15, wherein the determining of the data activity level occurs at periodic intervals.

17. The non-transitory computer readable media of claim 15, wherein the sending of the power packets further occurs during a low power sleep state of the personal computer.

18. The non-transitory computer readable media of claim 15, wherein the assigning is further based on one of a Wi-Fi profile, a location of the personal computer, and a user preference.

19. The non-transitory computer readable media of claim 15, wherein the transmission power level is set in response to a user preference.

20. The non-transitory computer readable media of claim 15, wherein the transmission power level is set in response to a user input from an augmented reality application that displays an effective range of the power packets from the personal computer according to the transmission power level.
